(19) United States
(12) Patent Application Publication
(10) Pub. No.: US 2018/0319695 A1
(43) Pub. Date: Nov. 8, 2018

(54) METHODS AND APPARATUSES FOR FORMING LAMINATED GLASS ARTICLES

(71) Applicant: Corning Incorporated, Corning, NY (US)

(72) Inventors: Alexey Sergeyevich Amosov, Avon (FR); James Gary Anderson, Dundee, NY (US); Kaushik Arumbuliyur Comandur, Painted Post, NY (US); Frank Coppola, Horseheads, NY (US); Hung Cheng Lu, Ithaca, NY (US); Anca Daniela Miller, Potsdam, NY (US); Ibraheem Rasool Muhammad, Horseheads, NY (US); Jon Anthony Passmore, Painted Post, NY (US); Michael Clement Ruotolo, Jr., Corning, NY (US); Zheming Zheng, Horseheads, NY (US)

(21) Appl. No.: 15/773,979

(22) PCT Filed: Nov. 3, 2016
(86) PCT No.: PCT/US16/60278

§ 371 Date: May 4, 2018

Related U.S. Application Data
(60) Provisional application No. 62/251,459, filed on Nov. 5, 2015.

(51) Int. Cl. C03B 17/06

(52) U.S. Cl. CPC C03B 17/068; C03B 17/064

(57) ABSTRACT

According to one embodiment, a method of forming a laminated glass ribbon may include flowing a molten glass core composition and a molten glass cladding composition in a vertically downward direction. The molten glass core composition may be contacted with the molten glass cladding composition to form the laminated glass ribbon comprising a glass core layer formed from the molten glass core composition and a glass cladding layer formed from the molten glass cladding composition. Core beads located proximate an edge of the glass core layer and clad beads located proximate an edge of the glass cladding layer may be compressed while the glass core layer and the glass cladding layers have viscosities greater than or equal to the viscosity at their softening points as the laminated glass ribbon is drawn in the vertically downward direction.

### BACKGROUND

This application claims the benefit of priority to U.S. Provisional Application No. 62/251459, filed Nov. 05, 2015, the content of which is incorporated herein by reference in its entirety.

### FIELD

The present specification generally relates to laminated glass articles and, more particularly, to methods and apparatuses for forming laminated glass ribbons with reduced thickness variations.

### TECHNICAL BACKGROUND

Glass forming apparatuses are commonly used to form various glass products such as laminated glass articles. These laminated glass articles may be used in a variety of applications including, without limitation, as cover glasses in electronic devices such as LCD displays, smart phones, and the like. The laminated glass articles may be manufactured by downwardly flowing streams of molten glass over a series of forming bodies and joining the molten glass streams to form a continuous, laminated glass ribbon. This forming process may be referred to as a fusion process or a laminate fusion process. Various properties of the glass ribbon, such as strength, optical characteristics, and the like, may be controlled by controlling the composition of the molten glass streams flowing over the forming bodies.

As the molten glass cools and solidifies, properties of the glass, such as compressive stress and tension, are fixed in the glass ribbon. While these properties are generally a function of the glass composition, they may also be affected by the actual forming process. Where the forming process results in the development of excessive tension in one portion of the ribbon, there is an increased likelihood that the glass ribbon will spontaneously fracture or “crack out”. These crack outs are a significant source of production inefficiencies and contribute to increased product costs.

Accordingly, a need exists for alternative methods and apparatuses which mitigate glass ribbon failures and thereby improve the stability and efficiency of manufacturing laminated glass articles.

### SUMMARY

According to one embodiment, a method of forming a laminated glass ribbon may include flowing a molten glass core composition in a vertically downward direction and flowing a molten glass cladding composition in the vertically downward direction. The molten glass core composition may be contacted with the molten glass cladding composition to form the laminated glass ribbon comprising a glass core layer formed from the molten glass core composition and a glass cladding layer formed from the molten glass cladding composition. The glass core layer may have a width that is greater than the glass cladding layer. Core beads located proximate an edge of the glass core layer may be compressed while the glass core layer has a viscosity greater than or equal to the viscosity at its softening point as the laminated glass ribbon is drawn in the vertically downward direction. Clad beads located proximate an edge of the glass cladding layer may be compressed while the glass cladding layer has a viscosity greater than or equal to the viscosity at its softening point as the laminated glass ribbon is drawn in the vertically downward direction, thereby mitigating the development of tensile stress in the clad beads.

According to another embodiment, an apparatus for forming a laminated glass ribbon may include an upper forming body comprising outer forming surfaces and a lower forming body disposed downstream of the upper forming body and comprising outer forming surfaces that converge at a root. A draw plane may extend in a downstream direction from the root, the draw plane defining a travel path of the laminated glass ribbon from the lower forming body. The apparatus may further include at least one pair of core edge rollers comprising a first core edge roll and a second core edge roll. The first core edge roll and the second core edge roll may be opposed to each other with the draw plane extending between the first core edge roll and the second core edge roll. The apparatus may further include at least one pair of clad edge rollers comprising a first clad edge roll and a second clad edge roll. The first clad edge roll and the second clad edge roll may be opposed to each other with the draw plane extending between the first clad edge roll and the second clad edge roll. The at least one pair of clad edge rollers may be positioned between the at least one pair of core edge rollers and a centerline of the draw plane such that the at least one pair of core edge rollers is contactable with core beads of the laminated glass ribbon drawn on the draw plane and the at least one pair of clad edge rollers is contactable with clad beads of the laminated glass ribbon drawn on the draw plane in the downstream direction. The at least one pair of clad edge rollers and the at least one pair of core edge rollers may be positioned above a glass transition zone of the draw plane.

In another embodiment, an apparatus for forming a laminated glass ribbon may include an upper forming body comprising outer forming surfaces and a lower forming body disposed downstream of the upper forming body and comprising outer forming surfaces that converge at a root. A draw plane may extend in a downstream direction from the root. The draw plane may define a travel path of the laminated glass ribbon from the lower forming body. The apparatus may further include at least one pair of core edge rollers comprising a first core edge roll and a second core edge roll. The first core edge roll and the second core edge roll may be opposed to each other with the draw plane extending between the first core edge roll and the second core edge roll. The apparatus may further include at least one pair of clad edge rollers comprising a first clad edge roll and a second clad edge roll. The first clad edge roll and the second clad edge roll may be opposed to each other with the draw plane extending between the first clad edge roll and the second clad edge roll. The at least one pair of clad edge rollers may be positioned between the at least one pair of core edge rollers and a centerline of the draw plane such that the at least one pair of core edge rollers are contactable with core beads of the laminated glass ribbon drawn on the draw plane and the at least one pair of clad edge rollers are contactable with clad beads of the laminated glass ribbon drawn on the draw plane in the downstream direction. An axis of rotation of the first clad edge roll and an axis of rotation of the first core edge roll may be coaxial. An axis of rotation of the second clad edge roll and an axis of rotation of the second core edge roll may be coaxial. The at least one pair of clad edge rollers and the at least one pair of core edge rollers may be positioned above a glass transition zone of the draw plane.

Additional features and advantages of the methods and apparatuses for forming laminated glass articles, such as laminated glass ribbons, will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts a cross section of a laminated glass article formed from a laminated glass ribbon;

FIG. 2 schematically depicts a glass forming apparatus for making a laminated glass ribbon;

FIG. 3 schematically depicts a portion of a draw plane of a glass forming apparatus with a laminated glass ribbon being drawn thereon;

FIG. 4 graphically depicts the thickness variations of a laminated glass ribbon as a function of distance from an edge of the laminated glass ribbon;

FIG. 5 schematically depicts a portion of a draw plane of a glass forming apparatus with a laminated glass ribbon being drawn thereon, according to one or more embodiments shown and described herein;

FIG. 6 schematically depicts a cross section of the laminated glass ribbon drawn on the draw plane of FIG. 5 according to one or more embodiments shown;

FIG. 7 schematically depicts a portion of a draw plane of a glass forming apparatus with a laminated glass ribbon being drawn thereon, according to one or more embodiments shown and described herein;

FIG. 8 schematically depicts a cross section of the laminated glass ribbon drawn on the draw plane of FIG. 7 according to one or more embodiments shown;

FIG. 9 schematically depicts a cross section of a clad edge roll and a core edge roll mounted to nested drive shafts, according to one or more embodiments shown and described herein;

FIG. 10 schematically depicts a portion of a draw plane of a glass forming apparatus with a laminated glass ribbon being drawn thereon, according to one or more embodiments shown and described herein;

FIG. 11 schematically depicts a partial cross section of an edge roll with macro-surface features according to one or more embodiments shown and described herein;

FIG. 12a graphically depicts the draw stress for a laminated glass ribbon in which both the core beads and the clad beads are contacted with edge rollers;

FIG. 12b graphically depicts the draw stress for a laminated glass ribbon in which only the core beads are contacted with edge rollers;

FIG. 13 graphically depicts the thickness profiles of laminated glass ribbons in which only the core beads are contacted with edge rollers and in which both the core beads and the clad beads are contacted with edge rollers;

FIG. 14 graphically depicts the thickness profiles of laminated glass ribbons in which only the core beads are contacted with edge rollers and in which both the core beads and the clad beads are contacted with an edge roller as depicted in FIG. 10;

FIG. 15 graphically depicts the vertical stress profiles of laminated glass ribbons in which only the core beads are contacted with edge rollers and in which both the core beads and the clad beads are contacted with an edge roller as depicted in FIG. 10;

FIG. 16a graphically depicts the shear stress profile of a laminated glass ribbon in which only the core beads are contacted with edge rollers; and

FIG. 16b graphically depicts the shear stress profile of a laminated glass ribbon in which both the core beads and the clad beads are contacted with an edge roller as depicted in FIG. 10.

### DETAILED DESCRIPTION

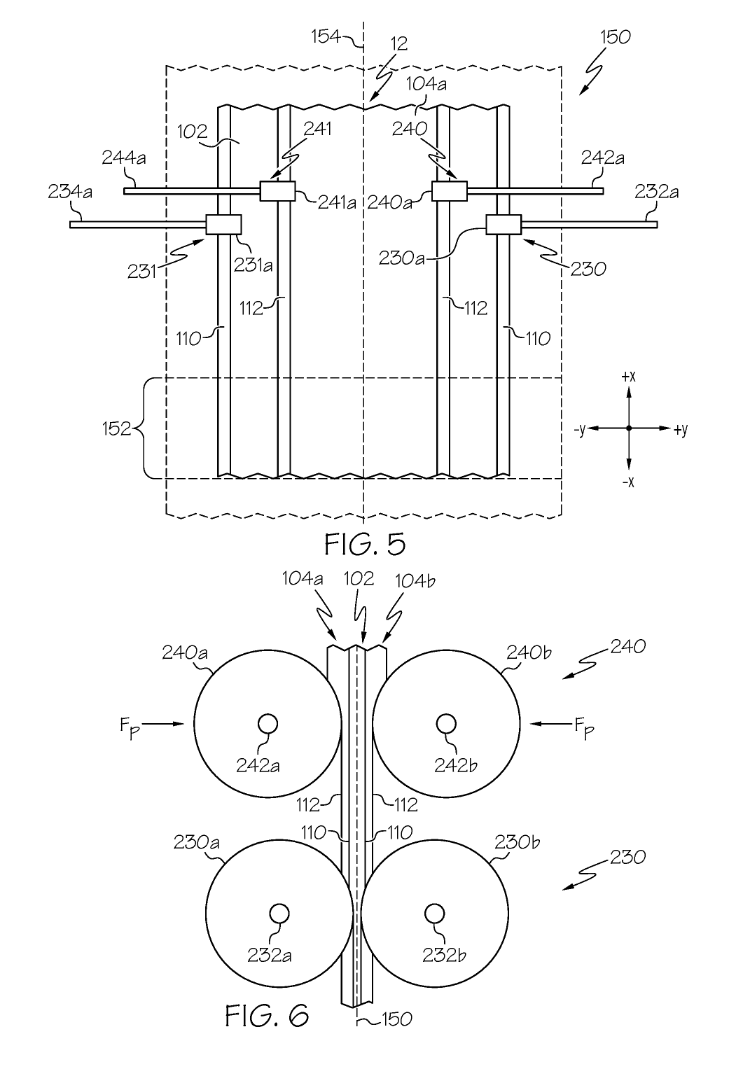

Reference will now be made in detail to embodiments of glass forming apparatuses and methods for using the same, examples of which are illustrated in the accompanying drawings. Whenever possible, the same reference numerals will be used throughout the drawings to refer to the same or like parts. One embodiment of a method for forming a laminated glass ribbon is schematically depicted in FIG. 5. In embodiments, the method for forming the laminated glass ribbon may include flowing a molten glass core composition in a vertically downward direction and flowing a molten glass cladding composition in the vertically downward direction. The molten glass core composition may be contacted with the molten glass cladding composition to form the laminated glass ribbon comprising a glass core layer formed from the molten glass core composition and a glass cladding layer formed from the molten glass cladding composition. The glass core layer may have a width that is greater than the glass cladding layer. Core beads located proximate an edge of the glass core layer may be compressed while the glass core layer has a viscosity greater than or equal to the viscosity at its softening point as the laminated glass ribbon is drawn in the vertically downward direction. Clad beads located proximate an edge of the glass cladding layer may be compressed while the glass cladding layer has a viscosity greater than or equal to the viscosity at its softening point as the laminated glass ribbon is drawn in the vertically downward direction, thereby mitigating the development of tensile stress in the clad beads. Various embodiments of methods and apparatuses for making laminated glass ribbons will be described in further detail herein with specific reference to the appended drawings.

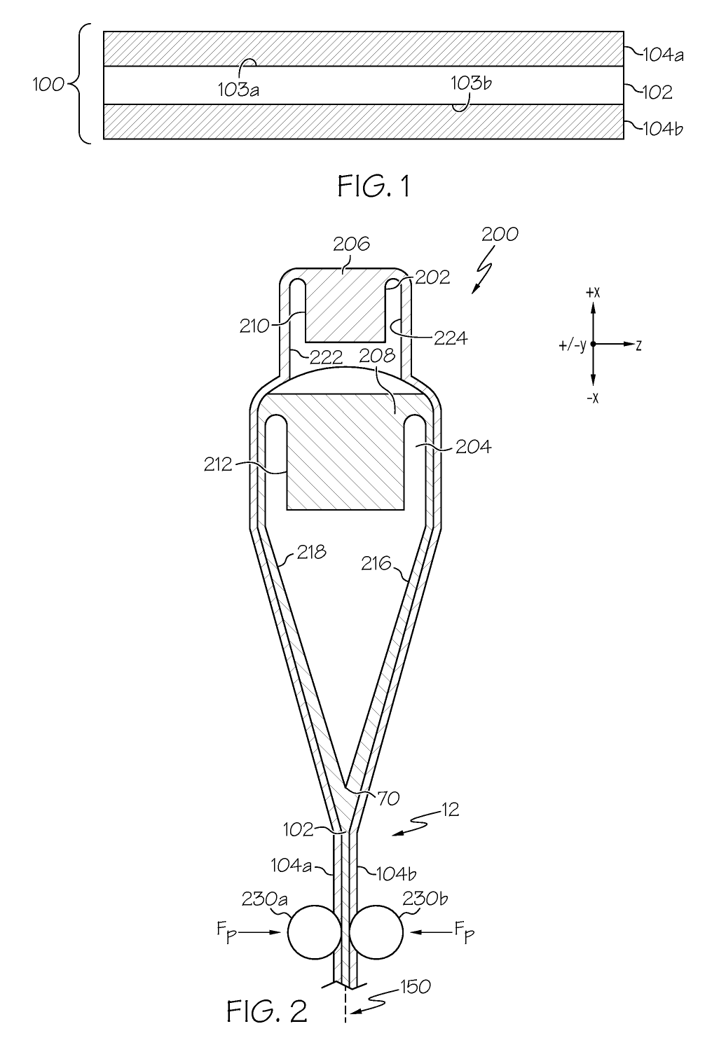

Referring now to FIG. 1, one embodiment of a laminated glass article 100 is schematically depicted in cross section. The laminated glass article 100 generally includes a glass core layer 102 and a pair of glass cladding layers 104a, 104b. The glass core layer 102 generally includes a first surface 103a and a second surface 103b opposite the first surface 103a. A first glass cladding layer 104a is fused to the first surface 103a of the glass core layer 102 and a second glass cladding layer 104b is fused to the second surface 103b of the glass core layer 102. The glass cladding layers 104a, 104b are fused to the glass core layer 102 without any additional materials, such as adhesives, coating layers or the like, disposed between the glass core layer 102 and the glass cladding layers 104a, 104b.

In some embodiments of the laminated glass article 100, the glass core layer 102 may be formed from a first glass composition having an average core coefficient of thermal expansion CTE_{core} and the glass cladding layers 104a, 104b are formed from a second, different glass composition which has an average cladding coefficient of thermal expansion CTE_{clad}. In this embodiment, the CTE_{core} is greater than CTE_{clad} which results in the glass cladding layers 104a, 104b being compressively stressed without being ion exchanged or thermally tempered. As used herein, the term “average coefficient of thermal expansion,” or “average CTE,” refers to the average coefficient of linear thermal expansion of a given material or layer between 0° C. and 300° C. As used herein, the term “coefficient of thermal expansion,” or “CTE,” refers to the average coefficient of thermal expansion unless otherwise indicated.

In some other embodiments, the glass core layer 102 and the glass cladding layers 104a, 104b may be formed from different glass compositions which have similar coefficients of thermal expansion but different physical properties. For example and without limitation, the glass core layer 102 may be more or less prone to dissolution in a particular solution than the glass cladding layers 104a, 104b. As another example, the glass core layer 102 and the glass cladding layers 104a, 104b may have different optical characteristics, such as index of refraction or the like.

Further, while FIG. 1 schematically depicts an embodiment of a laminated glass article 100 having three discrete layers of glass, it should be understood that, in other embodiments, the laminated glass article may be formed from two discrete layers of glass or more than three discrete layers of glass.

Referring now to FIGS. 1 and 2, the laminated glass article 100 of FIG. 1 may be formed by a fusion lamination process, such as the processes described in U.S. Pat. No. 4,214,886, filed Apr. 5, 1979 and entitled “Forming Laminated Sheet Glass,” and International Patent App. No. PCT/US2013/053357, filed Aug. 2, 2013 and entitled “Apparatus and Method for Producing Laminated Glass Sheet,” each of which is incorporated by reference herein.

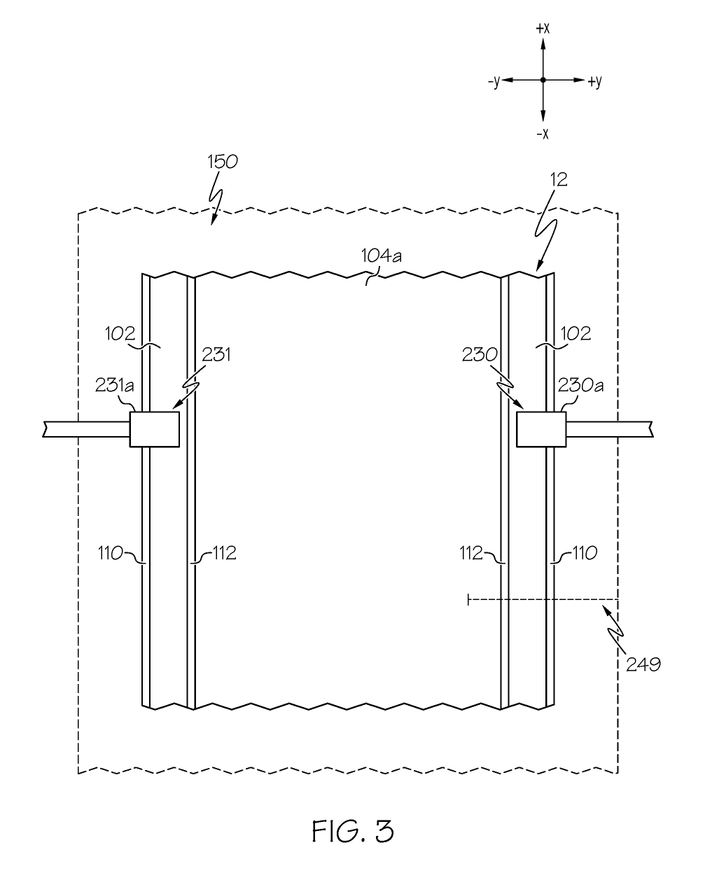

Referring to FIGS. 2 and 3 by way of example, a glass forming apparatus 200 for forming a laminated glass article includes a first, upper forming body 202 positioned over a second, lower forming body 204. That is, the lower forming body 204 is positioned downstream (i.e., in the −x-direction of the coordinate axes depicted in FIG. 2) of the upper forming body 202. The upper forming body 202 includes a trough 210 into which a molten glass cladding composition 206 is fed from a melter (not shown). Similarly, the lower forming body 204 includes a trough 212 into which a molten glass core composition 208 is fed from a melter (not shown).

As the molten glass core composition 208 fills the trough 212, it overflows the trough 212 and flows over the outer forming surfaces 216, 218 of the lower forming body 204. The outer forming surfaces 216, 218 of the lower forming body 204 converge at a root 70. The molten glass core composition 208 flowing over the outer forming surfaces 216, 218 rejoins at the root 70 of the lower forming body 204 thereby forming a glass core layer 102 of a laminated glass ribbon 12. A draw plane 150 extends from the root 70 in a downstream direction from the root 70 and generally defines the travel path of the glass core layer 102 from the lower forming body 204 as the molten glass core composition 208 leaves the lower forming body 204 at the root 70.

Simultaneously, the molten glass cladding composition 206 overflows the trough 210 formed in the upper forming body 202 and flows over outer forming surfaces 222, 224 of the upper forming body 202. The molten glass cladding composition 206 flows around the lower forming body 204 and contacts the molten glass core composition 208 flowing over the outer forming surfaces 216, 218 of the lower forming body 204, fusing to the molten glass core composition 208 and forming glass cladding layers 104a, 104b around the glass core layer 102, thereby forming a laminated glass ribbon 12, from which a laminated glass article 100 (FIG. 1) may be separated. The laminated glass ribbon 12 travels downstream of the upper forming body 202 and the lower forming body 204 along the draw plane 150 and is drawn in the downstream direction by, for example, gravity and/or pulling rolls (not shown) located downstream of the lower forming body 204.

As noted hereinabove, in some embodiments, the molten glass core composition 208 may have an average coefficient of thermal expansion CTE_{core} which is greater than the average cladding coefficient of thermal expansion CTE_{clad} of the molten glass cladding composition 206. The molten glass core composition 208 and the molten glass cladding composition may also have different viscosities. As the glass core layer 102 and the glass cladding layers 104a, 104b cool, the difference in the coefficients of thermal expansion cause a compressive stresses to develop in the glass cladding layers 104a, 104b due to the CTE mismatch between the glass core layer and the glass cladding layers. The compressive stress increases the strength of the resulting laminated glass article without an ion-exchange treatment or thermal tempering treatment.

Still referring to FIGS. 2 and 3, after the laminated glass ribbon 12 leaves the lower forming body 204 and is drawn along the draw plane 150, the glass core layer 102 of the laminated glass ribbon 12 may be contacted proximate its edges with pairs of opposed edge rollers 230, 231 (the edge rolls 230a, 230b of one pair of edge rollers 230 are schematically depicted in FIG. 2; FIG. 3 schematically depicts one core edge roll 230a, 231a from respective pairs of edge rollers 230, 231 contacting opposing edges of the laminated glass ribbon 12). These pairs of edge rollers 230, 231 grip the glass core layer 102 with a pinch force Fp and also apply a draw force to the laminated glass ribbon 12 in the −x-direction. The pairs of edge rollers 230, 231 also assist in maintaining the width of the laminated glass ribbon 12 in the +/−y-direction of the coordinate axes depicted in FIG. 2.

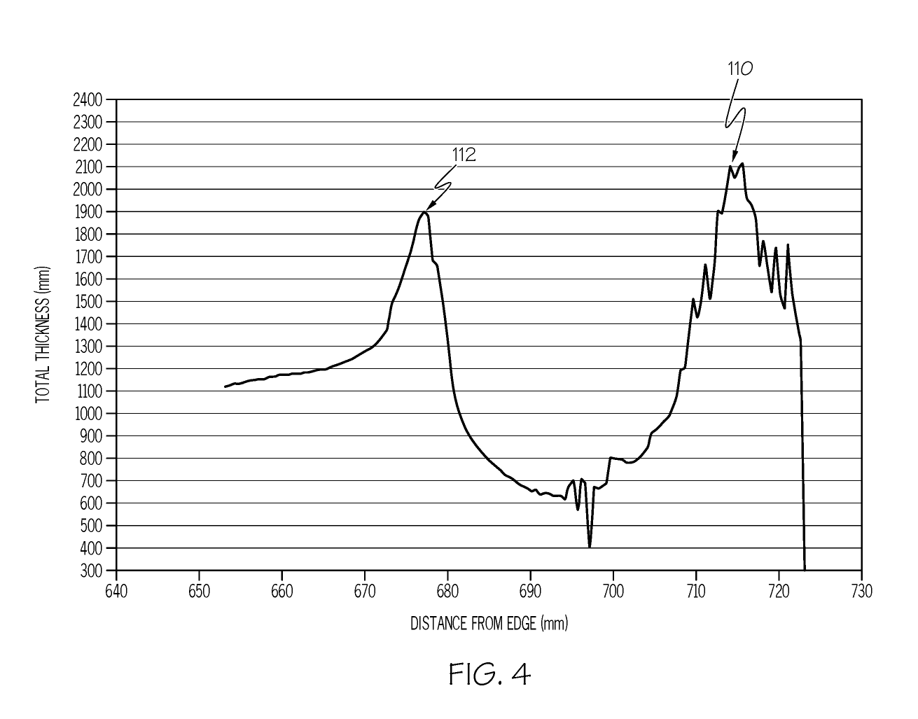

The molten glass flowing over the glass forming apparatus 200 may be subject to attenuation. As shown in FIG. 2, the upper forming body 202 may be spaced apart from the lower forming body 204. Attenuation occurs as the molten glass flowing from the upper forming body 202 tapers inwardly (i.e., attenuates) in a width-wise direction (i.e., the width of the molten glass stream is reduced in the +/−y-direction of the coordinate axes depicted in FIG. 2) as the molten glass transitions from the upper forming body 202 to the lower forming body over the interior gap disposed between the forming bodies. The attenuation is due, at least in part, to the spacing between the forming bodies, the drag of the molten glass relative to the forming body (or lack thereof), and the viscosity of the molten glass. The attenuation tends to result in the molten glass cladding composition 206 from the upper forming body 202 forming a thicker glass layer proximate the edges of the laminated glass ribbon 12. Similarly, the molten glass core composition 208 from the lower forming body 204 also forms a thicker glass layer proximate the edges of the laminated glass ribbon. These thickened portions are often referred to as beads and are schematically depicted in FIG. 3 as core beads 110 and clad beads 112. FIG. 4 graphically depicts the thickness variation of the laminated glass ribbon 12 in the +/−y-direction over line segment 249. As indicated in FIG. 4, the core beads 110 and the clad beads 112 have greater thickness that the remainder of the laminated glass ribbon 12. Thus, the core beads 110 comprise relatively thick regions of the glass core layer 102 disposed at opposing edges thereof, and the clad beads 112 comprise relatively thick regions of the laminated glass ribbon 12 disposed inboard of the core beads and at opposing edges of the clad layers 104a, 104b. The core beads 110 are relatively thick compared to the thickness of a region of the core layer 102 between the core beads 110 and the clad beads 112 and, in some embodiments, may be thicker than a central region of the laminated glass ribbon 12 disposed between the clad beads 112. Clad beads 112 are relatively thick compared to the thickness of a central region of the laminated glass ribbon 12 disposed between the clad beads 112.

It has now been found that the use of edge rolls to contact only the glass core layer 102 causes process instabilities and increases the propensity for spontaneous failure of the glass ribbon (i.e., crack outs). Specifically, it has been determined that the use of edge rolls to contact only the glass core layer 102 causes stretching and shearing of the glass at the boundary between the glass core layer 102 and the glass cladding layers 104a, 104b when the viscosity of the glass core layer 102 is lower than the viscosity of the glass cladding layers 104a, 104b, which, in turn, causes thickness variations in the width-wise direction of the glass ribbon, as depicted in FIG. 4. These thickness variations cause local temperature gradients and stress concentrations, leading to potential crack-outs and process instabilities. Further, when the viscosity of the glass core layer 102 is lower than the viscosity of the glass cladding layers 104a, 104b, and edge rolls are used to contact only the glass core layer 102, the thickness of the clad beads is increased due to attenuation of the glass forming the glass cladding layers 104a, 104b. The increase in the thickness of the clad beads 112 results in a low core/clad thickness ratio in a portion of the central region of the laminated glass ribbon 12 disposed between the clad beads 112. The increased thickness of the clad beads 112 also causes local temperature gradients and stress concentration in the glass transition zone and elastic zone of the manufacturing process, imposing a greater tension in the glass due, in part, to the CTE mismatch between the glass layers and in part to the increased thickness of the clad beads 112. Further, the resulting low core/clad thickness ratio causes high stress bands to develop in the laminated glass ribbon 12 where the glass cladding layers 104a, 104b are in tension and the glass core layer 102 is in compression. The increase in tension in various portions of the laminated glass ribbon 12 due to the increased thickness of the clad beads 112 may cause process instabilities and difficulties in scoring and separating discrete laminated glass articles from the laminated glass ribbon 12.

The embodiments of the methods and apparatuses for forming laminated glass articles described herein may reduce the thickness of the edge beads, thereby improving process stability and throughput of the glass forming apparatuses. Specifically, the glass forming apparatuses described herein include pairs of edge rollers which contact both the core beads 110 of the glass core layer 102 and the clad beads 112 of the glass cladding layers 104a, 104b above the glass transition zone of the draw plane 150 (i.e., where the glass material of the glass core layer 102 and the glass cladding layers 104a, 104b are both plastically deformable) to both mitigate the attenuation of the glass core layer 102 and the glass cladding layers 104a, 104b and to compress the core beads 110 and the clad beads 112 thereby mitigating the formation of tensile stress in the laminated glass ribbon 12 and reducing thickness variations in the width-wise direction of the glass ribbon (i.e., the +/−y-directions of the laminated glass ribbon 12).

Referring now to FIGS. 5 and 6, a portion of a laminated glass ribbon 12 traveling on the draw plane 150 of a glass forming apparatuses 200 (shown in FIG. 2) is schematically depicted according to one or more embodiments shown and described herein. The draw plane 150 includes a glass transition zone 152 located downstream of the lower forming body 204 and the edge rollers. As the laminated glass ribbon 12 is drawn in the downstream direction, the glass of the glass core layer 102 and the glass cladding layers 104a, 104b cools and solidifies such that, at or below the glass transition zone 152, the laminated glass ribbon 12 is solid glass. The glass core layers 102 and the glass cladding layers 104a, 104b are contacted with the respective edge rollers while the glass behaves like a viscous fluid. In embodiments, the viscosity of the glass core layers 102 and the glass cladding layers 104a, 104b is at or below the viscosity of the glass at its softening point (i.e., 1×10^{7.65} poise) when the glass is contacted by the respective edge rolls such that the glass is malleable. This position is generally above the glass transition zone of the draw plane 150. It should also be understood that the glass transition zone of a particular draw plane 150 may vary depending on the glass composition drawn on the draw plane 150. However, contact with between the glass and the respective edge rolls occurs above the glass transition zone where the glass has a viscosity at or below the viscosity of the glass at its softening point.

In the embodiment shown in FIGS. 5 and 6, the glass forming apparatus includes at least one pair of edge rollers which contact the core beads 110 of the glass core layer 102 and at least one pair of edge rollers which contact the clad beads 112 of the glass cladding layers 104a, 104b. Specifically, the glass forming apparatus includes two pairs of core edge rollers 230, 231 which contact the core beads 110 of the glass core layer 102 as the laminated glass ribbon 12 is drawn downstream. Each pair of core edge rollers 230, 231 includes a first core edge roll 230a, 231a and a second core edge roll 230b (the second core edge roll of the core edge rollers 231 is not depicted). The first core edge roll and the second core edge roll of each pair of core edge rollers 230, 231 are opposed to each other on opposite sides of the draw plane 150 such that the draw plane 150 extends between the first core edge roll and the second core edge roll of each pair of core edge rollers 230, 231. For example, as shown in FIGS. 5 and 6, the first core edge roll 230a and the second core edge roll 230b of the first pair of core edge rollers 230 are arranged on opposite sides of the draw plane 150 such that, when a laminated glass ribbon 12 is drawn on the draw plane 150, the laminated glass ribbon 12 and, more specifically, the core beads 110 located on one edge of the glass core layer 102 of the laminated glass ribbon 12, are impinged between the first core edge roll 230a and the second core edge roll 230b of the pair of core edge rollers 230. While the relative orientation of the core edge rolls of the pair of core edge rollers 231 is not depicted in FIGS. 5 and 6, it should be understood that the orientation of the core edge rolls of the pair of core edge rollers 231 relative to the draw plane 150 and the laminated glass ribbon 12 is similar to that of the pair of core edge rollers 230 although on the opposite edge of the draw plane 150 and the laminated glass ribbon 12.

In the embodiment depicted in FIGS. 5 and 6, each of the core edge rolls of the pairs of core edge rollers 230, 231 are affixed to separate drive shafts such that the angular velocity of each pair of core edge rollers 230, 231 may be separately controlled. For example, the first core edge roll 230a of the pair of core edge rollers 230 may be affixed to a first drive shaft 232a while the second core edge roll 230b may be affixed to a second drive shaft 232b to facilitate rotation of the respective core edge rolls 230a, 230b. Each drive shaft 232a, 232b of the pair of core edge rollers 230 may be coupled to an actuator (not shown), such as a motor or the like, to impart an angular velocity to the drive shaft and, in turn the attached core edge roll. In one embodiment, each drive shaft 232a, 232b of the pair of core edge rollers 230 is coupled to a separate actuator. In this embodiment, the angular velocity of each core edge roll 230a, 230b may be independently controlled through the separate actuators. In other embodiments, the drive shafts 232a, 232b of the pair of core edge rollers 230 may be coupled to a common actuator, such as through a transmission linkage or the like, such that the angular velocity of the core edge rolls 230a, 230b may be synchronized with the transmission linkage.

Similarly, the first core edge roll 231a of the pair of core edge rollers 231 may be affixed to a first drive shaft 234a while the second core edge roll (not shown) may be affixed to a second drive shaft (not shown) to facilitate rotation of the respective core edge rolls of the pair of core edge rolls 231, as described above with respect to FIGS. 5 and 6. For example, each drive shaft of the pair of core edge rollers 231 may be coupled to an actuator (not shown), such as a motor or the like, to impart an angular velocity to the drive shaft and, in turn, the attached core edge roll. In one embodiment, each drive shaft of the pair of core edge rollers 231 is coupled to a separate actuator. In this embodiment, the angular velocity of each core edge roll of the pair of core edge rollers 231 may be independently controlled through the separate actuators. In other embodiments, the drive shafts affixed to each core edge roll of the pair of core edge rollers 231 may be coupled to a common actuator, such as through a transmission linkage or the like, such that the angular velocity of the core edge rolls of the pair of core edge rollers 231 may be synchronized with the transmission linkage.

Still referring to FIGS. 5 and 6, in this embodiment, the glass forming apparatus further includes two pairs of clad edge rollers 240, 241 which contact the clad beads 112 of the glass cladding layers 104a, 104b as the laminated glass ribbon 12 is drawn downstream. Each pair of clad edge rollers 240, 241 includes a first clad edge roll 240a, 241a and a second clad edge roll 240b (the second clad edge roll of the clad edge rollers 241 is not depicted). The first clad edge roll and the second clad edge roll of each pair of clad edge rollers 240, 241 are opposed to each other on opposite sides of the draw plane 150 such that the draw plane 150 extends between the first clad edge roll and the second clad edge roll of each pair of clad edge rollers 240, 241. For example, as shown in FIGS. 5 and 6, the first clad edge roll 240a and the second clad edge roll 240b of the first pair of clad edge rollers 240 are arranged on opposite sides of the draw plane 150 such that, when a laminated glass ribbon 12 is drawn on the draw plane 150, the laminated glass ribbon 12 and, more specifically, the clad beads 112 located on one edge of the glass cladding layers 104a, 104b of the laminated glass ribbon 12, are impinged between the first clad edge roll 240a and the second clad edge roll 240b of the pair of clad edge rollers 240. While the relative orientation of the clad edge rolls of the pair of clad edge rollers 241 is not depicted in FIGS. 5 and 6, it should be understood that the orientation of the clad edge rolls of the pair of clad edge rollers 241 relative to the draw plane 150 and the laminated glass ribbon 12 is similar to that of the pair of clad edge rollers 240 although on the opposite edge of the draw plane 150 and the laminated glass ribbon 12.

In the embodiment depicted in FIGS. 5 and 6, each of the clad edge rolls of the pairs of clad edge rollers 240, 241 are affixed to separate drive shafts such that the angular velocity of each pair of clad edge rollers 240, 241 may be separately controlled. For example, the first clad edge roll 240a of the pair of clad edge rollers 240 may be affixed to a first drive shaft 242a while the second clad edge roll 240b may be affixed to a second drive shaft 242b to facilitate rotation of the respective clad edge rolls 240a, 240b. Each drive shaft 242a, 242b of the pair of clad edge rollers 240 may be coupled to an actuator (not shown), such as a motor or the like, to impart an angular velocity to the drive shaft and, in turn the attached clad edge roll. In one embodiment, each drive shaft 242a, 242b of the pair of clad edge rollers 240 is coupled to a separate actuator. In this embodiment, the angular velocity of each clad edge roll 240a, 240b may be independently controlled through the separate actuators. In other embodiments, the drive shafts 242a, 242b of the pair of clad edge rollers 240 may be coupled to a common actuator, such as through a transmission linkage or the like, such that the angular velocity of the clad edge rolls 240a, 240b may be synchronized with the transmission linkage.

Similarly, the first clad edge roll 241a of the pair of clad edge rollers 241 may be affixed to a first drive shaft 234a while the second clad edge roll (not shown) may be affixed to a second drive shaft (not shown) to facilitate rotation of the respective clad edge rolls of the pair of clad edge rollers 241, as described above with respect to FIGS. 5 and 6. For example, each drive shaft of the pair of clad edge rollers 241 may be coupled to an actuator (not shown), such as a motor or the like, to impart an angular velocity to the drive shaft and, in turn, the attached clad edge roll. In one embodiment, each drive shaft of the pair of clad edge rollers 241 is coupled to a separate actuator. In this embodiment, the angular velocity of each clad edge roll of the pair of clad edge rollers 241 may be independently controlled through the separate actuators. In other embodiments, the drive shafts affixed to each clad edge roll of the pair of clad edge rollers 241 may be coupled to a common actuator, such as through a transmission linkage or the like, such that the angular velocity of the clad edge rolls of the pair of clad edge rollers 241 may be synchronized with the transmission linkage.

In the embodiments described herein, the pairs of clad edge rollers 240, 241 are positioned between a respective pair of core edge rollers 230, 231 and a centerline 154 of the draw plane 150 such that the pairs of core edge rollers 230, 231 are in contact with core beads 110 of the laminated glass ribbon 12 drawn on the draw plane 150 and the pairs of clad edge rollers 240, 241 are located inboard of the core edge rollers 230, 231 in a width-wise direction of the draw plane 150 and in contact with clad beads 112 of the laminated glass ribbon drawn 12 drawn on the draw plane 150 in the downstream direction. In embodiments, the pairs of clad edge rollers 240, 241 and the pairs of core edge rollers 230, 231 are positionable in the width-wise direction of the draw plane 150 to facilitate proper alignment of the rollers on the core beads 110 and the clad beads 112.

While FIGS. 5 and 6 schematically depict the pairs of clad edge rollers 240, 241 positioned upstream of the pairs of core edge rollers 230, 231, it should be understood that, in other embodiments, the pairs of clad edge rollers 240, 241 may be positioned downstream of the pairs of core edge rollers 230, 231.

In one embodiment, the diameter of the edge rolls of the pairs of clad edge rollers 240, 241 may be greater than or equal to the diameter of the edge rolls of the pairs of core edge rollers 230, 231. Use of clad edge rolls with diameters larger than the diameter of the core edge rolls of the pairs of core edge rollers 230, 231 allows for a greater pinch force Fₚ to be applied to the clad beads 112 of the laminated glass ribbon 12 as the laminated glass ribbon is drawn through the clad edge rollers 240, 241. The greater pinch force Fₚ compresses the clad beads 112, mitigating the formation of tensile stress in the laminated glass ribbon 12 and reducing thickness variations in the width-wise direction of the glass ribbon (i.e., the +/−y-directions) of the laminated glass ribbon 12.

In embodiments, having the core edge rollers 230, 231 and the clad edge rollers 240, 241 mounted on independent drive shafts allows for the angular velocity of the core edge rollers 230, 231 and the clad edge rollers 240, 241 to be independently controlled. In embodiments, the clad edge rollers 240, 241 and the core edge rollers 230, 231 are rotated at different angular velocities in order to mitigate the formation of tensile stress in the laminated glass ribbon 12 and reduce thickness variations in the width-wise direction of the glass ribbon (i.e., the +/−y-directions) of the laminated glass ribbon 12 as the laminated glass ribbon 12 is drawn on the draw plane 150 in order to achieve a uniform thickness profile in the width-wise direction of the laminated glass ribbon 12. In this embodiment, the diameter of the clad edge rolls of the clad edge rollers 240, 241 may be greater than or equal to the diameter of the core edge rolls of the core edge rollers 230, 231.

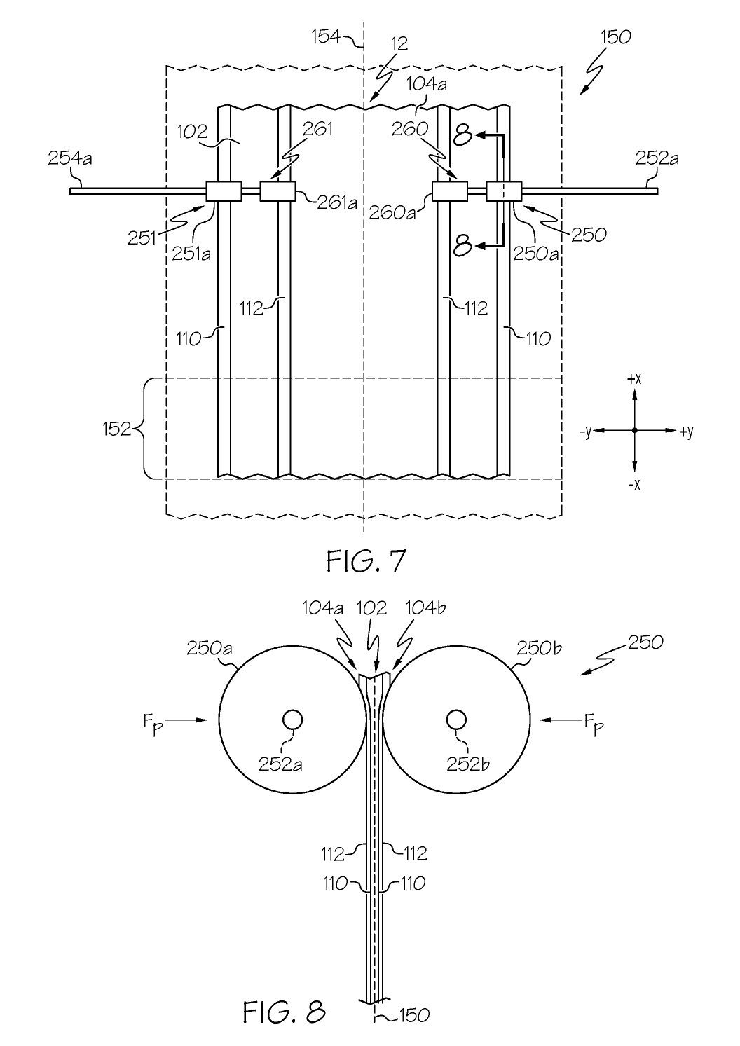

Referring now to FIGS. 7 and 8, in another embodiment, the glass forming apparatus includes at least one pair of edge rollers which contact the core beads 110 of the glass core layer 102 and at least one pair of edge rollers which contact the clad beads 112 of the glass cladding layers 104a, 104b, as described above with respect to FIGS. 5 and 6. Specifically, the glass forming apparatus includes two pairs of core edge rollers 250, 251 which contact the core beads 110 of the glass core layer 102 as the laminated glass ribbon 12 is drawn downstream. Each pair of core edge rollers 250, 251 includes a first core edge roll 250a, 251a and a second core edge roll 250b (the second core edge roll of the core edge rollers 251 is not depicted). The first core edge roll and the second core edge roll of each pair of core edge rollers 250, 251 are opposed to each other on opposite sides of the draw plane 150 such that the draw plane 150 extends between the first core edge roll and the second core edge roll of each pair of core edge rollers 250, 251. For example, as shown in FIGS. 7 and 8, the first core edge roll 250a and the second core edge roll 250b of the first pair of core edge rollers 250 are arranged on opposite sides of the draw plane 150 such that, when a laminated glass ribbon 12 is drawn on the draw plane 150, the laminated glass ribbon 12 and, more specifically, core beads 110 located on one edge of the glass core layer 102 of the laminated glass ribbon 12, are impinged between the first core edge roll 250a and the second core edge roll 250b of the pair of core edge rollers 250. While the relative orientation of the core edge rolls of the pair of core edge rollers 251 is not depicted in FIGS. 7 and 8, it should be understood that the orientation of the core edge rolls of the pair of core edge rollers 251 relative to the draw plane 150 and the laminated glass ribbon 12 is similar to that of the pair of core edge rollers 250, although on the opposite edge of the draw plane 150 and the laminated glass ribbon 12.

Still referring to FIGS. 7 and 8, in this embodiment, the glass forming apparatus further includes two pairs of clad edge rollers 260, 261 which contact the clad beads 112 of the glass cladding layers 104a, 104b as the laminated glass ribbon 12 is drawn downstream. Each pair of clad edge rollers 260, 261 includes a first clad edge roll 260a, 261a and a second clad edge roll (the second clad edge roll of the clad edge rollers 260 and the second clad edge roll of the clad edge rollers 261 are not depicted). The first clad edge roll and the second clad edge roll of each pair of clad edge rollers 260, 261 are opposed to each other on opposite sides of the draw plane 150 such that the draw plane 150 extends between the first clad edge roll and the second clad edge roll of each pair of clad edge rollers 260, 261, in a similar manner as described above with respect to the core edge rollers 250, 251 depicted in FIGS. 7 and 8. For example, the first clad edge roll 260a and the second clad edge roll of the first pair of clad edge rollers 260 are arranged on opposite sides of the draw plane 150 such that, when a laminated glass ribbon 12 is drawn on the draw plane 150, the laminated glass ribbon 12 and, more specifically, the clad beads 112 located on one edge of the glass cladding layers 104a, 104b of the laminated glass ribbon 12, are impinged between the first clad edge roll 260a and the second clad edge roll of the pair of clad edge rollers 260. While the relative orientation of the clad edge rolls of the pair of clad edge rollers 261 is not depicted in FIGS. 7 and 8, it should be understood that the relative orientation of the clad edge rolls of the pair of clad edge rollers 261 relative to the draw plane 150 and the laminated glass ribbon 12 is similar to that of the pair of clad edge rollers 260 although on the opposite edge of the draw plane 150 and the laminated glass ribbon 12.

In the embodiment depicted in FIGS. 7 and 8, one clad edge roll of a pair of clad edge rollers and one core edge roll of a pair of core edge rollers are affixed to a common drive shaft. For example, the first core edge roll 250a of the core edge rollers 250 and the first clad edge roll 260a of the clad edge rollers 260 are affixed to drive shaft 252a such that rotation of the drive shaft 252a rotates both the first core edge roll 250a and the first clad edge roll 260a. In this embodiment, the axis of rotation of the first core edge roll 250a and the axis of rotation of the first clad edge roll 260a are coaxial. Similarly, the second core edge roll 250b of the core edge rollers 250 and the second clad edge roll (not shown) of the clad edge rollers 260 are affixed to drive shaft 252b such that rotation of the drive shaft 252b rotates both the second core edge roll 250b and the second clad edge roll. Thus, as above, the axis of rotation of the second core edge roll 250b and the axis of rotation of the second clad edge roll are coaxial. Each drive shaft 252a, 252b may be coupled to an actuator (not shown), such as a motor or the like, to impart an angular velocity to the drive shaft and, in turn the attached clad edge roll and core edge roll. In one embodiment, each drive shaft 252a, 252b is coupled to a separate actuator. In this embodiment, the angular velocity may be independently controlled through the separate actuators and synchronized, such as through a control system or the like. In other embodiments, the drive shafts 252a, 252b may be coupled to a common actuator, such as through a transmission linkage or the like, such that the angular velocity of the drive shafts 252a, 252b may be synchronized with the transmission linkage.

Similarly, the first core edge roll 251a of the core edge rollers 251 and the first clad edge roll 261a of the clad edge rollers 261 are affixed to drive shaft 254a such that rotation of the drive shaft 254a rotates both the first core edge roll 251a and the first clad edge roll 261a. In this embodiment, the axis of rotation of the first core edge roll 251a and the axis of rotation of the first clad edge roll 261a are coaxial. Although not specifically depicted in the figures, it should be understood that, in this embodiment, the second core edge roll of the core edge rollers 251 and the second clad edge roll of the clad edge rollers 261 are also affixed to a common drive shaft such that rotation of the drive shaft rotates both the second core edge roll of the core edge rollers 251 and the second clad edge roll of the clad edge rollers 261. Thus, as above, the axis of rotation of the second core edge roll of the core edge rollers 251 and the axis of rotation of the second clad edge roll of the clad edge rollers 261 are coaxial. The drive shaft 254a attached to the first core edge roll 251a of the core edge rollers 251 and the first clad edge roll 261a of the clad edge rollers 261 and the drive shaft attached to the second core edge roll of the core edge rollers 251 and the second clad edge roll of the clad edge rollers 261 may be coupled to an actuator (not shown), such as a motor or the like, to impart an angular velocity to the drive shaft and, in turn the attached clad edge roll and core edge roll. In one embodiment, each drive shaft is coupled to a separate actuator. In this embodiment, the angular velocity may be independently controlled through the separate actuators and synchronized, such as through a control system or the like. In other embodiments, the drive shafts may be coupled to a common actuator, such as through a transmission linkage or the like, such that the angular velocity of the drive shafts may be synchronized with the transmission linkage.

In the embodiments described herein, the pairs of clad edge rollers 260, 261 are positioned between a respective pair of core edge rollers 250, 251 and a centerline 154 of the draw plane 150 such that the pairs of core edge rollers 250, 251 are in contact with core beads 110 of the laminated glass ribbon 12 drawn on the draw plane 150 and the pairs of clad edge rollers 260, 261 are located inboard of the core edge roller 250, 251 in a width-wise direction of the draw plane 150 and in contact with clad beads 112 of the laminated glass ribbon 12 drawn on the draw plane 150. In embodiments, the pairs of clad edge rollers 260, 261 and the pairs of core edge rollers 250, 251 are positionable in the width-wise direction of the draw plane 150 to facilitate proper alignment of the rollers on the core beads 110 and the clad beads 112. That is, the pairs of clad edge rollers 260, 261 and the pairs of core edge rollers 250, 251 may be positionable on their respective drive shafts in the width-wise direction of the draw plane 150. Further, as described above, both the clad edge rollers 260, 261 and the core edge rollers 250, 251 are positioned upstream of the glass transition zone 152 such that the clad edge rollers 260, 261 and the core edge rollers 250, 251 contact the laminated glass ribbon 12 while the glass of the laminated glass ribbon 12 is plastically deformable.

In the embodiment depicted in FIGS. 7 and 8, the diameter of the edge rolls of the pairs of clad edge rollers 260, 261 may be greater than or equal to the diameter of the edge rolls of the pairs of core edge rollers 250, 251. Use of clad edge rolls with diameters larger than the diameter of the core edge rolls allows for a greater pinch force Fₚ to be applied to the clad beads 112 of the laminated glass ribbon 12 as the laminated glass ribbon is drawn through the clad edge rollers 240, 241. The greater pinch force Fₚ compresses the clad beads 112, mitigating the formation of tensile stress in the laminated glass ribbon 12 and reducing thickness variations in the width-wise direction of the glass ribbon (i.e., the +/−y-directions) of the laminated glass ribbon 12.

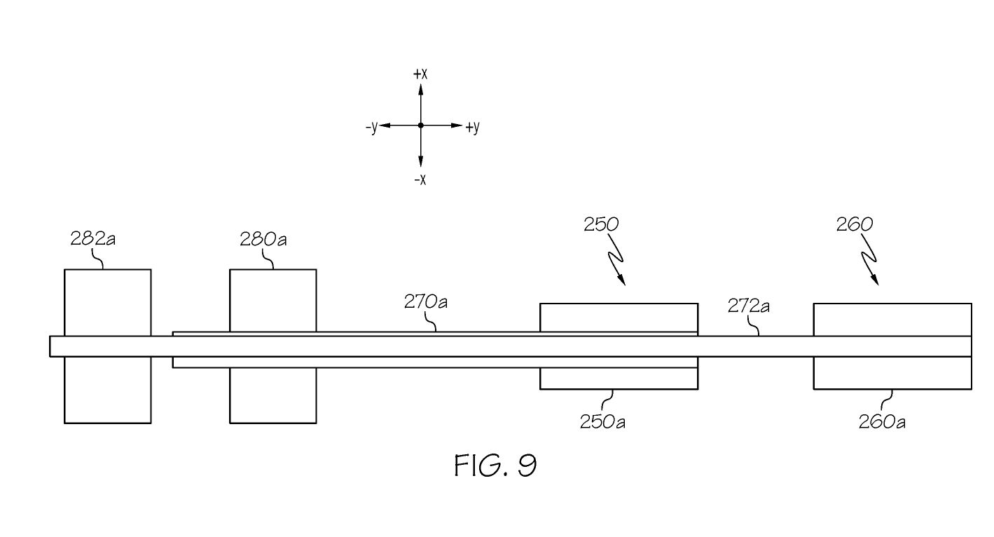

While FIGS. 7 and 8 depict an embodiment of a glass forming apparatus in which one clad edge roll of a pair of clad edge rollers and one core edge roll of a pair of core edge rollers are affixed to a common drive shaft, it should be understood that other embodiments are contemplated and possible. For example, FIG. 9 schematically depicts an alternative embodiment in which a core edge roll of a pair of core edge rollers and a clad edge roll of a pair of clad edge rollers are attached to separate drive shafts with one drive shaft extending through the other drive shaft in a nested or telescoping arrangement. Further, while FIGS. 7 and 8 schematically depict edge rollers on opposing edges of the glass ribbon affixed to a common drive shaft, in other embodiments, all four edge rollers on one side of the glass ribbon can be affixed to a common drive shaft.

Specifically referring to FIG. 9, an axial cross section of an embodiment of a first core edge roll 250a of a pair of core edge rollers 250 and a first clad edge roll 260a of a pair of clad edge rollers 260 is schematically depicted. In this embodiment, the core edge roll 250a of the core edge rollers 250 is attached to a first drive shaft 270a. The first drive shaft 270a may be, for example, a hollow tube or cylinder. An actuator 280a, such as a motor or the like, is attached to the outer diameter of the first drive shaft 270a to facilitate rotation of the first drive shaft 270a and the first core edge roll 250a. The clad edge roll 260a of the clad edge rollers 260 is attached to a second drive shaft 272a. The second drive shaft 272a may be, for example a solid or hollow tube or cylinder that extends through the first drive shaft 270a. An actuator 282a, such as a motor or the like, is attached to the outer diameter of the second drive shaft 272a to facilitate rotation of the second drive shaft 272a and the firs clad edge roll 260a.

The nested configuration of the first and second drive shafts 270a, 272a allows for the drive shafts to be rotated independent of one another by their respective actuators 280a, 282a. Accordingly, it should be understood that the clad edge roll 260a of the clad edge rollers 260 and the core edge roll 250a of the core edge rollers 250 in this embodiment may be rotated at different angular velocities, as described hereinabove with respect to FIGS. 5 and 6. The nested configuration of the first and second drive shafts 270a, 272a also allows for the relative position of the core edge roll 250a and the clad edge roll 260a to be adjusted in the width-wise direction so that the core edge roll 250a and the clad edge roll 260a can be positioned on the respective core beads and clad beads of a laminated glass ribbon.

Still referring to FIG. 9, in some embodiments, the diameter of the clad edge roll 260a of the clad edge rollers 260 may be greater than or equal to the diameter of the core edge rolls 250a of the core edge rollers 250. As noted herein, use of clad edge rolls with diameters larger than the diameter of the core edge rolls allows for a greater pinch force to be applied to the clad beads of the laminated glass ribbon. The greater pinch force Fp compresses the clad beads, mitigating the formation of tensile stress in the laminated glass ribbon and reducing thickness variations in the width-wise direction of the glass ribbon (i.e., the +/−y-directions) of the laminated glass ribbon.

In embodiments, the first drive shaft 270a and the second drive shaft 272a may be concentric such that an axis of rotation of the first clad edge roll 260a and an axis of rotation of the first core edge roll 250a are coaxial. However, it should be understood that the first drive shaft 270a and the second drive shaft 272a need not be concentric and that, in alternative embodiments, the axis of rotation of the first clad edge roll 260a and an axis of rotation of the first core edge roll 250a are non-coaxial, such as when the axis of rotation of the first clad edge roll 260a and an axis of rotation of the first core edge roll 250a are parallel with one another but non-coaxial.

For purposes of clarity, FIG. 9 depicts a single core edge roll 250a of a pair of core edge rollers 250 and a single clad edge roll 260a of a pair of clad edge rollers 260 affixed to nested drive shafts. However, it should be understood that each pair of core edge rollers and the corresponding pairs of clad edge rollers may be similarly constructed. For example, in the embodiment shown in FIGS. 7 and 8, the first core edge roll 250a of the core edge rollers 250 may be affixed to a first drive shaft and the first clad edge roll 260a of the at least one pair of clad edge rollers 260 may be affixed to a second drive shaft that extends through the first drive shaft, as shown in FIG. 9. Similarly, the second core edge roll 250b of the core edge rollers 250 may be affixed to a third drive shaft and the second clad edge roll (not shown) of the pair of clad edge rollers 260 may be affixed to a fourth drive shaft that extends through the third drive shaft.

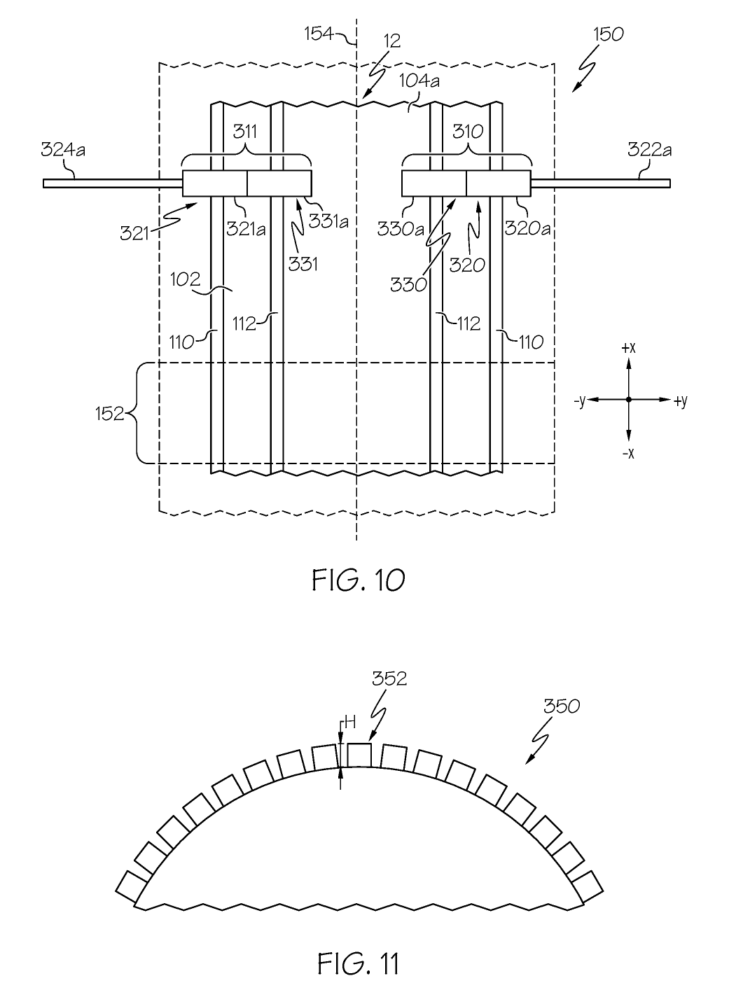

While FIGS. 5-9 depict embodiments of glass forming apparatuses which have pairs of discrete core edge rollers and pairs of discrete clad edge rollers, it should be understood that other embodiments are contemplated and possible. For example, referring to FIG. 10, in another embodiment, the glass forming apparatus includes edge rolls which contact the core beads 110 of the glass core layer 102 and edge rolls which contact the clad beads 112 of the glass cladding layers 104a, 104b, as described above with respect to FIGS. 5-8. However, in this embodiment, the core edge rolls and the clad edge rolls are formed as a single roll with discrete portions which contact the clad beads 112 and discrete portions that contact the core beads 110. Specifically, the glass forming apparatus includes two pairs of edge rollers 310, 311 which contact the core beads 110 of the glass core layer 102 and the clad beads of the glass cladding layers 104a, 104b as the laminated glass ribbon 12 is drawn downstream. Each pair of edge rollers 310, 311 includes at least one pair of core edge rollers 320 including a first core edge roll 320a, 321a and a second core edge roll (the second core edge roll of the core edge rollers 320 and the second core edge roll of the core edge rollers 321 are not depicted). The first core edge roll and the second core edge roll of each pair of core edge rollers 320, 321 are opposed to each other on opposite sides of the draw plane 150 such that the draw plane 150 extends between the first core edge roll and the second core edge roll of each pair of core edge rollers 320, 321, as shown and described above with respect to FIGS. 5-8.

Each pair of edge rollers 310, 311 further includes pairs of clad edge rollers 330, 331 which contact the clad beads 112 of the glass cladding layers 104a, 104b as the laminated glass ribbon 12 is drawn downstream. Each pair of clad edge rollers 330, 331 includes a first clad edge roll 330a, 331a and a second clad edge roll (the second clad edge roll of the clad edge rollers 330 and the second clad edge roll of the clad edge rollers 331 are not depicted). The first clad edge roll and the second clad edge roll of each pair of clad edge rollers 330, 331 are opposed to each other on opposite sides of the draw plane 150 such that the draw plane 150 extends between the first clad edge roll and the second clad edge roll of each pair of clad edge rollers 330, 331, in a similar manner as described above with respect to the clad edge rollers 260, 261 depicted in FIGS. 5-8.

However, in this embodiment, a core edge roll of a pair of core edge rollers and a clad edge roll of a pair of clad edge rollers are attached to one another or otherwise formed as a unitary whole such that the edge rollers 310, 311 have sufficient length to extend between and contact both the clad beads 112 and the core beads 110 on one edge of the laminated glass ribbon 12. This allows the core edge roll and the clad edge roll to be rotated in synchronization with one another while contacting and compressing both the clad beads 112 and the core beads 110.

In the embodiment depicted in FIG. 10, the edge roller 310 is affixed to a drive shaft 322a such that rotation of the drive shaft 322a rotates both the first core edge roll 320a and the first clad edge roll 330a. In this embodiment, the axis of rotation of the first core edge roll 320a and the axis of rotation of the first clad edge roll 330a are coaxial. Similarly, the second core edge roll (not shown) of the core edge rollers 320 and the second clad edge roll (not shown) of the clad edge rollers 330 are affixed to a common drive shaft such that rotation of the drive shaft rotates both the second core edge roll and the second clad edge roll. Thus, as above, the axis of rotation of the second core edge roll and the axis of rotation of the second clad edge roll are coaxial. Each drive shaft may be coupled to an actuator (not shown), such as a motor or the like, to impart an angular velocity to the drive shaft and, in turn the attached clad edge roll and core edge roll. In one embodiment, each drive shaft is coupled to a separate actuator. In this embodiment, the angular velocity may be independently controlled through the separate actuators and synchronized, such as through a control system or the like. In other embodiments, the drive shafts may be coupled to a common actuator, such as through a transmission linkage or the like, such that the angular velocity of the drive shafts may be synchronized with the transmission linkage.

Similarly, the edge roller 311 is affixed to a drive shaft 324a such that rotation of the drive shaft 324a rotates both the first core edge roll 321a and the first clad edge roll 331a. In this embodiment, the axis of rotation of the first core edge roll 321a and the axis of rotation of the first clad edge roll 331a are coaxial. Although not specifically depicted in the figures, it should be understood that, in this embodiment, the second core edge roll of the core edge rollers 321 and the second clad edge roll of the clad edge rollers 331 are also affixed to a common drive shaft such that rotation of the drive shaft rotates both the second core edge roll of the core edge rollers 321 and the second clad edge roll of the clad edge rollers 331. Thus, as above, the axis of rotation of the second core edge roll of the core edge rollers 321 and axis of rotation of the second clad edge roll of the clad edge rollers 331 are coaxial. The drive shaft 324a attached to the first core edge roll 321a of the core edge rollers 321 and the first clad edge roll 331a of the clad edge rollers 331 and the drive shaft attached to the second core edge roll of the core edge rollers 321 and the second clad edge roll of the clad edge rollers 331 may be coupled to an actuator (not shown), such as a motor or the like, to impart an angular velocity to the drive shaft and, in turn the attached clad edge roll and core edge roll. In one embodiment, each drive shaft is coupled to a separate actuator. In this embodiment, the angular velocity may be independently controlled through the separate actuators and synchronized, such as through a control system or the like. In other embodiments, the drive shafts may be coupled to a common actuator, such as through a transmission linkage or the like, such that the angular velocity of the drive shafts may be synchronized with the transmission linkage.

In this embodiment, the edge rollers 310, 311 are constructed such that pairs of clad edge rollers 330, 331 are positioned between a respective pair of core edge rollers 320, 321 and a centerline 154 of the draw plane 150 such that the pairs of core edge rollers 320, 321 are in contact with core beads 110 of the laminated glass ribbon 12 drawn on the draw plane 150 and the pairs of clad edge rollers 330, 331 are located inboard of the core edge roller 320, 321 in a width-wise direction of the draw plane 150 and in contact with clad beads 112 of the laminated glass ribbon 12 drawn on the draw plane 150. As described above, in this embodiment both the clad edge rollers 330, 331 and the core edge rollers 320, 321 are positioned upstream of the glass transition zone 152 such that the clad edge rollers 330, 331 and the core edge rollers 320, 321 contact the laminated glass ribbon 12 while the glass of the laminated glass ribbon 12 is plastically deformable.

In the embodiment depicted in FIG. 10, the diameter of the edge rolls of the pairs of clad edge rollers 330, 331 may be greater than or equal to the diameter of the edge rolls of the pairs of core edge rollers 320, 321. Use of clad edge rolls with diameters larger than the diameter of the core edge rolls allows for a greater pinch force Fₚ to be applied to the clad beads 112 of the laminated glass ribbon 12 as the laminated glass ribbon is drawn through the clad edge rollers 330, 331. The greater pinch force Fₚ compresses the clad beads 112, mitigating the formation of tensile stress in the laminated glass ribbon 12 and reducing thickness variations in the width-wise direction of the glass ribbon (i.e., the +/−y-directions) of the laminated glass ribbon 12.

In the embodiments described herein, the core edge rolls and the clad edge rolls may be formed from material suitable to withstand prolonged exposure to high temperatures, such as the temperatures experienced in conventional glass manufacturing process, without loss of mechanical integrity. For example, in one embodiment, the core edge rolls and the clad edge rolls may be formed from nickel or nickel-based alloys or cobalt or cobalt-based alloys such as Stellite-6 or the like.

In the embodiments described herein, the core edge rolls and the clad edge rolls may both have smooth contact surfaces without variations in surface topography, such as ridges, grooves, spikes, knurls or the like. For example, in some embodiments, the core edge rolls and the clad edge rolls may have smooth contact surfaces with a surface roughness Ra less than about 5 microns. For Example, in embodiments, the surface roughness Ra of the core edge rolls and the clad edge rolls may be greater than 0 microns and less than about 5 microns. In some other embodiments, the surface roughness Ra of the core edge rolls and the clad edge rolls may be from about 1 micron to about 4 microns or even from about 1 micron to about 3 microns. The smooth contact surfaces allow the core edge rolls and the clad edge rolls to compress and deform the glass without the glass sticking to the edge rolls.

In some other embodiments, the core edge rolls and the clad edge rolls may have macro-featured surfaces formed by machining, etching, or the like, such that the surface roughness of the edge rolls is greater than that of edge rolls having a smooth contact surface (i.e., the surface roughness Ra of the macro-featured surface is greater than or equal to 5 microns). For example, the surface roughness may be greater than or equal to about 5 microns up to about 1500 microns or even greater. Referring to FIG. 11 by way of example, an enlarged view of a portion of a core edge roll 350 is schematically depicted. The core edge roll 350 includes a plurality of projections 352, such as spikes, teeth, ridges, knurling, or the like, which extend to a height H. The projections 352 may be regular or, alternatively, irregular. In the embodiments described herein, the height H of the projections 352 is less than 50% of a thickness of the portion of the laminated glass ribbon which the projections contact. For example, as the core edge roll 350 is used to contact the edge beads of a laminated glass ribbon, the height H of the projections 352 of the core edge roll 350 are less than 50% of a thickness of the glass core layer of the laminated glass ribbon such that the projections do not perforate through the thickness of the glass core layer of the laminated glass ribbon. In embodiments where the clad edge rolls include projections, the projections extend to a height H that is less than 50% of the thickness of the laminated glass ribbon so that the projections do not perforate through the thickness of the laminated glass ribbon.

The macro-featured surfaces of the core edge rolls and/or the clad edge rolls improve the traction of the edge roll against the glass, enhancing the downward pulling force of the edge roll against the glass and also preventing the plastically deformable glass from attenuating and decreasing in width as the glass is downwardly drawn.

In some embodiments, the core edge rolls and the clad edge rolls may have different finishes. For example, in some embodiments, the core edge rolls have macro-featured contact surfaces while the clad edge rolls have smooth contact surfaces with a surface roughness Ra less than about 5 microns. In this embodiment, the macro-featured surfaces of the core edge rolls that contact the core beads of the glass core layer of the laminated glass ribbon improve the traction of the core edge rolls against the glass core layer, improving the draw force applied to the laminated glass ribbon by the core edge rollers and also preventing the glass core layer from attenuating prior to solidification. The smooth contact surface of the clad edge rolls that contact the clad beads of the laminated glass ribbon prevent the clad edge rolls from sticking to the glass as the clad edge rolls compress the clad beads, reducing width-wise thickness variations in the laminated glass ribbon, and mitigating the development of tensile stress in the laminated glass ribbon.

It should now be understood that the apparatuses described herein may be used to reduce thickness variations in the width-wise direction of the laminated glass ribbon and also mitigate the development of tensile stresses in the laminated glass ribbon due to the formation of clad beads. Specifically, the glass forming apparatuses described may be used to form a laminated glass ribbon by flowing a molten glass core composition in a vertically downward direction from a lower forming body as depicted in FIG. 2. Simultaneously, a molten glass cladding composition may flow from an upper forming body situated over the lower forming body such that the molten cladding glass composition flows from the upper forming body in the vertically downward direction. As shown in FIG. 2, the molten glass core composition is contacted with the molten glass cladding composition to form a laminated glass ribbon comprising a glass core layer formed from the molten glass core composition and a glass cladding layer formed from the molten glass cladding composition. Based on the relative dimensions of the upper forming body and the lower forming body, the glass core layer has a width in the width-wise direction that is greater than the glass cladding layers.

As the laminated glass ribbon is drawn in the downward direction, the core beads located proximate the edges of the glass core layer are compressed by impinging the core beads between rotating core edge rolls, as depicted in FIGS. 5, 7, and 10. Contacting the core beads with core edge rolls not only decreases the thickness of the core beads, but also provides a downward draw force or tension in the downward direction while mitigating the attenuation of the glass core layer in the width-wise direction. The clad beads located proximate an edge of the glass cladding layer are also compressed by impinging the clad beads between rotating clad edge rolls as depicted in FIGS. 5, 7, and 10. Contacting the clad beads with the rotating clad edge rolls reduces the thickness of the clad beads, thereby decreasing the thickness variations in the width-wise direction of the laminated glass ribbon as the ribbon is drawn in the vertically downward direction. In addition, contacting the clad beads with the rotating clad edge rolls mitigates the development of tensile stress in the clad beads and adjacent areas of the laminated glass ribbon. The mitigation of the formation of tensile stresses improves the stability of the laminated glass sheet by reducing the occurrence of spontaneous fractures (so-called “crack outs”) which, in turn, improves the stability and throughput of the process of manufacturing the laminated glass ribbon. Further, the reduction in the tensile stress in the clad beads also improves the throughput of downstream processes, such as the process of separating a discrete laminated glass article from the laminated glass ribbon.

### EXAMPLES

The embodiments described herein will be further clarified by the following examples.

### Example 1

A computer simulation was developed to determine how the thickness, width and stress of a laminated glass ribbon vary under different processing conditions (i.e., contacting the core beads only or contacting both the core beads and the cladding beads). Specifically, it has been determined that the clad beads of the laminated glass ribbon are caused by the force redistribution due to the viscosity difference between the cladding layers of the laminated glass ribbon and core layer extending from the opposed edges of the laminated glass ribbon. Based on the asymptotic expansion method, thin viscous sheet equations were derived to describe the free hanging viscous glass sheet in the fusion draw process:

$$\frac{\partial ( hu )}{\partial x} + \frac{\partial ( hv )}{\partial y} = 0 , \\ \frac{\partial ( {hP}_{xx} )}{\partial x} + \frac{\partial ( {hP}_{xy} )}{\partial y} = - ρ gh , and$$

$$\frac{\partial ( {hP}_{xy} )}{\partial x} + \frac{\partial ( {hP}_{yy} )}{\partial y} = 0$$

where x is the down-draw direction coordinate, y is the cross-draw direction coordinate, h, u, v are the glass sheet thickness, down-draw velocity and cross-draw velocity, respectively, p is the density, g is standard gravity, and

$${P}_{xx} = 2 μ ( 2 \frac{\partial u}{\partial x} + \frac{\partial v}{\partial y} ) , \\ {P}_{yy} = 2 μ ( \frac{\partial u}{\partial x} + 2 \frac{\partial v}{\partial y} ) , and$$

$${P}_{xy} = μ ( \frac{\partial u}{\partial y} + \frac{\partial v}{\partial x} )$$

are the down-draw, cross-draw and shearing viscous stress, respectively, and p is the viscosity. By assuming the glass core layer and the glass clad layers have the same velocity and considering the effective viscosity of the laminated glass ribbon by averaging the viscosity through the glass core layer and the glass cladding layers, the viscous sheet equations can be derived for the laminated glass ribbon. Solving these viscous sheet equations using the Finite Element method, the thickness, width and stress of the laminated glass ribbon can be determined for the different drawing conditions.

A numerical simulation model was built based on the aforementioned equations and applied to study the effect of contacting the laminated glass ribbon with (a) independent core edge rolls and clad edge rolls applied to the core beads and clad beads, respectively; (b) only core edge rolls applied to the core beads; and (c) a wide edge roller comprising joined core edge rolls and clad edge rolls, as depicted in FIG. 10.

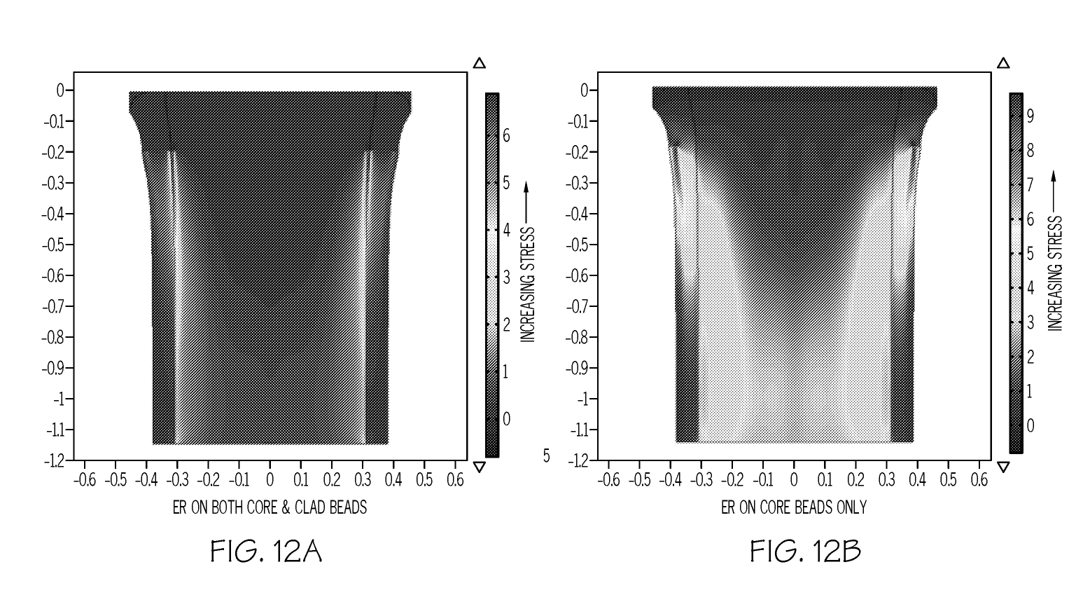

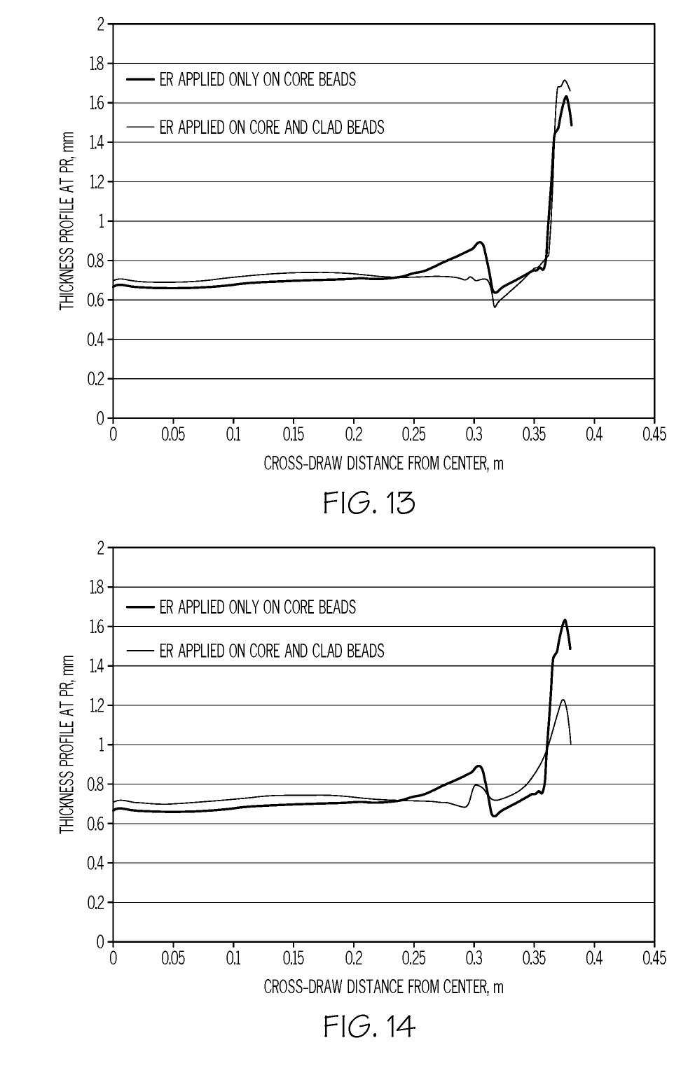

Referring to FIGS. 12a and 12b, the modeled down-draw stress is graphically depicted for (a) edge rolls applied to both the core beads and the clad beads and (b) edge rolls applied only on the core beads. As shown in FIGS. 12a and 12b, applying the edge rolls only on the core beads (FIG. 12b) causes stretching and shearing at the interface of the cladding glass layers and the core glass layers which results in clad beads with increased thickness, leading to higher stresses in the laminated glass ribbon. However, when edge rolls are applied to both core beads and the clad beads (FIG. 12a) as described herein, the edge rolls on the core beads mitigate attenuation of the laminated glass ribbon and the edge rolls on the clad beads providing sufficient down-draw force to hold the laminated glass ribbon and reduce the thickness of the clad beads and preserve the attributes (i.e., stress, thickness) of the laminated glass ribbon. The final thickness profile of the laminated glass ribbon evaluated below the glass transition zone is graphically depicted in FIG. 13 for both modeled conditions. As shown in FIG. 13, applying separate edge rolls on both core and clad beads reduces the thickness variation and generates a more uniform thickness profile in the widthwise direction relative to the edge rolls being applied to only the core beads.

A subsequent model was run to compare edge rolls applied only to the core beads and an edge roll as shown in FIG. 10 applied to both the core beads and the clad beads. The model was run using a width of 25 mm for the edge roll applied only to the core beads and a width of 120 mm for the edge roll applied to both the core beads and the clad beads (i.e., as depicted in FIG. 10). FIG. 14 shows the thickness profile of the laminated glass ribbon below the glass transition zone for both conditions. As shown in FIG. 14, the wide edge roll applied to both the core beads and the clad beads redistributes the mass of the glass such that there is less thickness difference between the center of the ribbon and the clad beads. In addition, the thickness profile proximate the center of the laminated glass ribbon in the width-wise direction has a more uniform distribution when an edge roll is used which contacts both the clad beads and core beads simultaneously. The wider edge roll contacting both the clad beads and the core beads is able to reduce the bead thickness by about 200 μm.

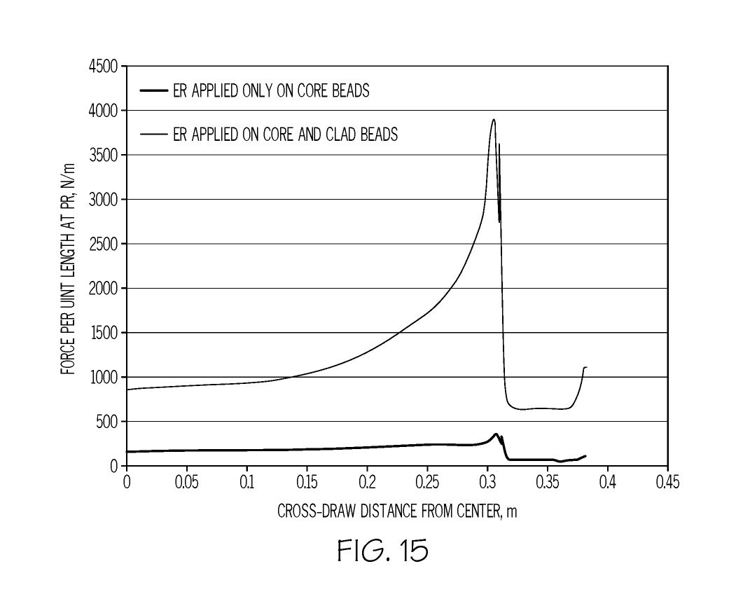

FIG. 15 graphically depicts the force distribution below the glass transition zone for both modeled conditions. Specifically, FIG. 15 shows that the pulling force is much larger when using the wider edge roll contacting both the clad beads and the core beads, which could provide more vertical tension in the laminated glass ribbon. The higher vertical tension may prevent ribbon buckling across the draw and improves draw stability.

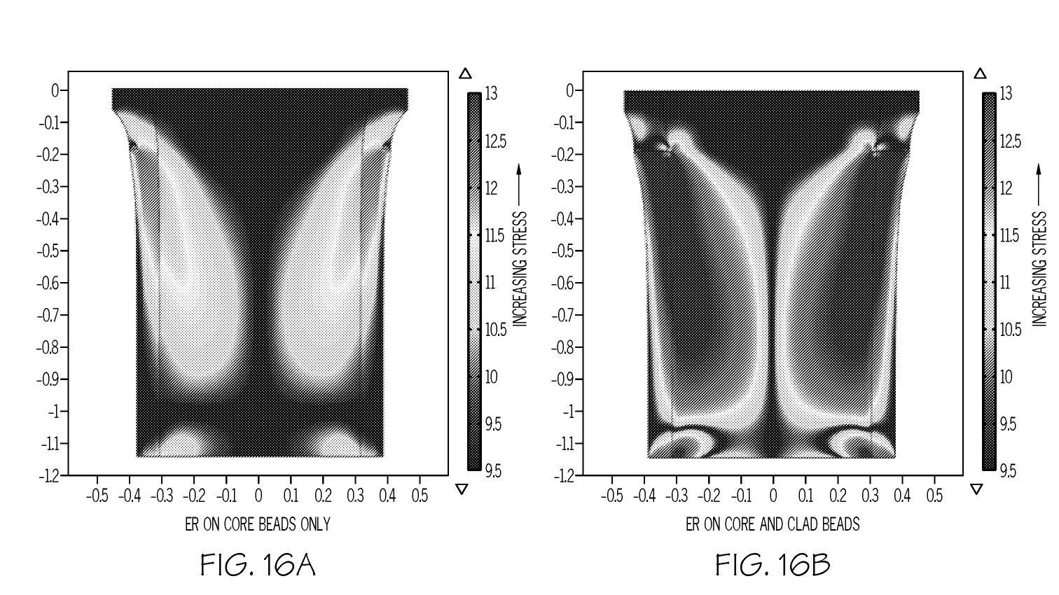

FIGS. 16a and 16b graphically depict the shear stress for (a) edge rolls only applied to the core beads and (b) edge rolls applied to both the core beads and the clad beads. The modeling results of FIG. 16a show that the shear stress profile from the edge rolls only applied to the core beads creates a discontinuity at the clad bead region which may cause wrinkle defects in high viscosity mismatched glass pairs. In contrast, FIG. 16b shows that the wider edge roll applied to both the core beads and the clad beads yields a shear stress that is relatively uniform from the edge of ribbon to the center of the ribbon. The uniformity of the stress profile reduces the propensity of bead buckling and improves process stability.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. A method of forming a laminated glass ribbon, the method comprising:
flowing a molten glass core composition in a vertically downward direction;
flowing a molten glass cladding composition in the vertically downward direction;
contacting the molten glass core composition with the molten glass cladding composition to form the laminated glass ribbon comprising a glass core layer formed from the molten glass core composition and a glass cladding layer formed from the molten glass cladding composition, wherein the glass core layer has a width that is greater than the glass cladding layer;
compressing core beads located proximate an edge of the glass core layer while the glass core layer has a viscosity greater than or equal to the viscosity at its softening point as the laminated glass ribbon is drawn in the vertically downward direction; and
compressing clad beads located proximate an edge of the glass cladding layer while the glass cladding layer has a viscosity greater than or equal to the viscosity at its softening point as the laminated glass ribbon is drawn in the vertically downward direction, thereby mitigating the development of tensile stress in the clad beads.

2. The method of claim 1, wherein:
compressing the core beads comprises impinging the core beads between a first core edge roll and a second core edge roll of at least one pair of core edge rollers; and
compressing the clad beads comprises impinging the clad beads between a first clad edge roll and a second clad edge roll of at least one pair of clad edge rollers.

3. The method of claim 2, wherein the first clad edge roll and the second clad edge roll of the at least one pair of clad edge rollers have diameters greater than the first core edge roll and the second core edge roll of the at least one pair of core edge rollers.

4. The method of claim 2, comprising rotating the at least one pair of clad edge rollers and the at least one pair of core edge rollers at different angular velocities.

5. The method of claim 2, wherein the first core edge roll of the at least one pair of core edge rollers and the first clad edge roll of the at least one pair of clad edge rollers are affixed to a common drive shaft and a diameter of the first clad edge roll is greater than a diameter of the first core edge roll.

6. The method of claim 2, wherein the first core edge roll of the at least one pair of core edge rollers is affixed to a first drive shaft and the first clad edge roll of the at least one pair of clad edge rollers is affixed to a second drive shaft, wherein one of the first drive shaft and the second drive shaft extends through the other of the first drive shaft and the second drive shaft.

7. The method of claim 6, wherein the first drive shaft and the second drive shaft are rotated at different angular velocities.

8. The method of claim 2, wherein:
the first clad edge roll and the second clad edge roll of the at least one pair of clad edge rollers have smooth contact surfaces with a surface roughness Ra less than 5 microns; and
the first core edge roll and the second core edge roll of the at least one pair of core edge rollers have macro-featured contact surfaces comprising a plurality of projections having a height that is less than 50% of a thickness of the glass core layer of the laminated glass ribbon.

9. An apparatus for forming a laminated glass ribbon, the apparatus comprising:
an upper forming body comprising outer forming surfaces;
a lower forming body disposed downstream of the upper forming body and comprising outer forming surfaces that converge at a root;
a draw plane extending in a downstream direction from the root, the draw plane defining a travel path of the laminated glass ribbon from the lower forming body;
at least one pair of core edge rollers comprising a first core edge roll and a second core edge roll, wherein the first core edge roll and the second core edge roll are opposed to each other with the draw plane extending between the first core edge roll and the second core edge roll; and
at least one pair of clad edge rollers comprising a first clad edge roll and a second clad edge roll, wherein the first clad edge roll and the second clad edge roll are opposed to each other with the draw plane extending between the first clad edge roll and the second clad edge roll, wherein:
the at least one pair of clad edge rollers is positioned between the at least one pair of core edge rollers and a centerline of the draw plane such that the at least one pair of core edge rollers is contactable with core beads of the laminated glass ribbon drawn on the draw plane and the at least one pair of clad edge rollers is contactable with clad beads of the laminated glass ribbon drawn on the draw plane in the downstream direction; and
the at least one pair of clad edge rollers and the at least one pair of core edge rollers are positioned above a glass transition zone of the draw plane.

10. The apparatus of claim 9, wherein the first clad edge roll and the second clad edge roll of the at least one pair of clad edge rollers have diameters greater than the first core edge roll and the second core edge roll of the at least one pair of core edge rollers.

11. The apparatus of claim 9, wherein the at least one pair of clad edge rollers and the at least one pair of core edge rollers rotate at different angular velocities.

12. The apparatus of claim 9, wherein the first core edge roll of the at least one pair of core edge rollers and the first clad edge roll of the at least one pair of clad edge rollers are affixed to a common drive shaft and a diameter of the first clad edge roll is greater than a diameter of the first core edge roll.

13. The apparatus of claim 9, wherein the first core edge roll of the at least one pair of core edge rollers is affixed to a first drive shaft and the first clad edge roll of the at least one pair of clad edge rollers is affixed to a second drive shaft, wherein one of the first drive shaft and the second drive shaft extends through the other of the first drive shaft and the second drive shaft.

14. The apparatus of claim 13, wherein the first drive shaft and the second drive shaft rotate at different angular velocities.

15. The apparatus of claim 9, wherein:
the first clad edge roll and the second clad edge roll of the at least one pair of clad edge rollers have smooth contact surfaces with a surface roughness RA less than 5 microns; and
the first core edge roll and the second core edge roll of the at least one pair of core edge rollers have a macro-featured contact surfaces comprising a plurality of projections having a height that is less than 50% of a thickness of a glass core layer of the laminated glass ribbon.

16. An apparatus for forming a laminated glass ribbon, the apparatus comprising:
an upper forming body comprising outer forming surfaces;
a lower forming body disposed downstream of the upper forming body and comprising outer forming surfaces that converge at a root;
a draw plane extending in a downstream direction from the root, the draw plane defining a travel path of the laminated glass ribbon from the lower forming body;
at least one pair of core edge rollers comprising a first core edge roll and a second core edge roll, wherein the first core edge roll and the second core edge roll are opposed to each other with the draw plane extending between the first core edge roll and the second core edge roll; and
at least one pair of clad edge rollers comprising a first clad edge roll and a second clad edge roll, wherein the first clad edge roll and the second clad edge roll are opposed to each other with the draw plane extending between the first clad edge roll and the second clad edge roll, wherein:
the at least one pair of clad edge rollers are positioned between the at least one pair of core edge rollers and a centerline of the draw plane such that the at least one pair of core edge rollers are contactable with core beads of the laminated glass ribbon drawn on the draw plane and the at least one pair of clad edge rollers are contactable with clad beads of the laminated glass ribbon drawn on the draw plane in the downstream direction;
an axis of rotation of the first clad edge roll and an axis of rotation of the first core edge roll are coaxial;
an axis of rotation of the second clad edge roll and an axis of rotation of the second core edge roll are coaxial; and
the at least one pair of clad edge rollers and the at least one pair of core edge rollers are positioned above a glass transition zone of the draw plane.

17. The apparatus of claim 16, wherein the first clad edge roll and the second clad edge roll of the at least one pair of clad edge rollers have diameters greater than the first core edge roll and the second core edge roll of the at least one pair of core edge rollers.

18. The apparatus of claim 16, wherein the first core edge roll of the at least one pair of core edge rollers and the first clad edge roll of the at least one pair of clad edge rollers are affixed to a common drive shaft.

19. The apparatus of claim 16, wherein the first core edge roll of the at least one pair of core edge rollers is affixed to a first drive shaft and the first clad edge roll of the at least one pair of clad edge rollers is affixed to a second drive shaft, wherein one of the first drive shaft and the second drive shaft extends through the other of the first drive shaft and the second drive shaft.

20. The apparatus of claim 16, wherein:
the first clad edge roll and the second clad edge roll of the at least one pair of clad edge rollers have smooth contact surfaces with a surface roughness RA less than 5 microns; and
the first core edge roll and the second core edge roll of the at least one pair of core edge rollers have a macro-featured contact surfaces comprising a plurality of projections having a height that is less than 50% of a thickness of a glass core layer of the laminated glass ribbon.
